(19) United States
(12) Patent Application Publication
(10) Pub. No.: US 2007/0063046 A1
(43) Pub. Date: Mar. 22, 2007

(54) System and method for assistance in the set-up of a new device to operate within a current system configuration

(76) Inventor: Louis A. Lippincott, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,829

(22) Filed: Sep. 22, 2005

(51) Int. Cl. G06K 7/10

(52) U.S. Cl. 235/462.15

(57) ABSTRACT

A method and system for assisting a user in the set-up of a new device to operate within a current system configuration are described. The method may involve identifying a new device to be added to a current system configuration, where the new device is identified via a Universal Product Code (UPC) number. Based on the current system configuration, customized set-up instructions are determined to enable the new device to operate within the current system configuration.

### BACKGROUND

The importance for the consumer electronic device industry to continuously strive to produce devices that are convenient to use cannot be overstated. No doubt this is one of the reasons for making devices that can be connected to one's current home or office system network or configuration. But, the ease of connecting a device to a system configuration often correlates to a person's understanding of how his or her current system operates. Often times the standard set-up instructions provided with a new device are not helpful when trying to integrate the new device within the existing or current system configuration.

A poor understanding of one's system configuration and unhelpful standard set-up instructions often result in the failure to be able to properly set-up a new device within the current system. Unfortunately for the consumer electronic device industry, the solution much too often is to simply box the new device back up and return it to the store. This solution results in lost revenue for the consumer electronic device industry.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for assisting a user in the set-up of a new device to operate within a current system configuration, in which some embodiments of the present invention may operate;

FIG. 2 illustrates a possible device identifier, according to an embodiment of the invention;

FIGS. 3A and 3B is a flow diagram of one embodiment of a process for the operation of assisting a user in the set-up of a new device to operate within a current system configuration;

FIG. 4 is a flow diagram of one embodiment of a process for identifying the new device to be added to the current system configuration;

FIG. 5 is a flow diagram of one embodiment of a process for identifying the new device to be added to the current system configuration; and

FIG. 6 is a flow diagram of one embodiment of a process for determining how the new device can be set-up with the system based on the current system configuration.

### DESCRIPTION OF EMBODIMENTS

According to an embodiment of the invention, a method and system for assisting a user in the set-up of a new device to operate within a current system configuration are described. When the user brings a new device into the home or office, the present invention provides customized set-up instructions to the user to assist in the easy integration of the new device with his or her current system configuration. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

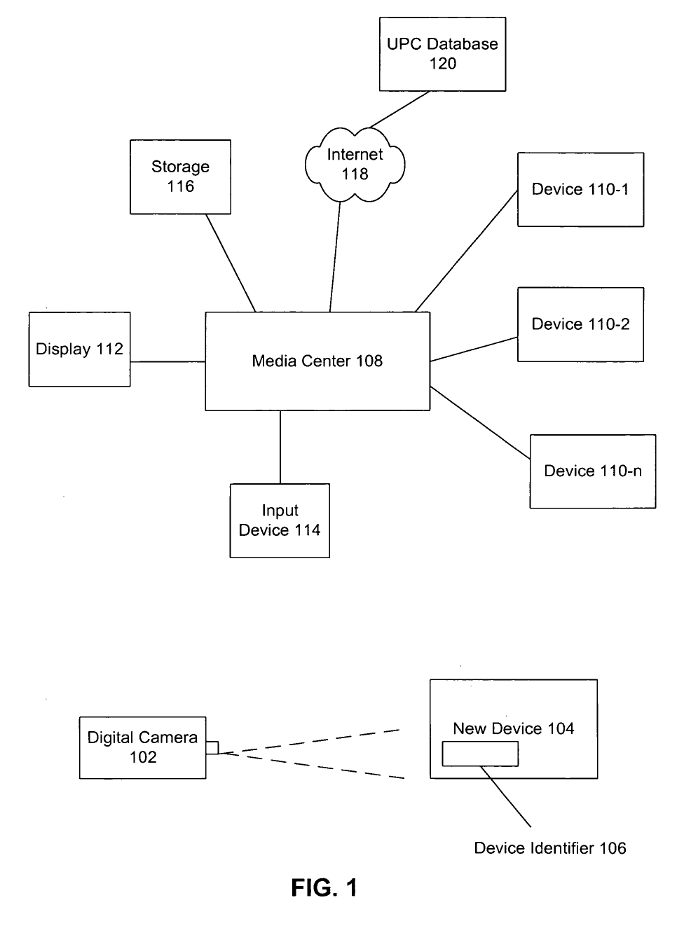

FIG. 1 illustrates one embodiment of an environment for assisting a user in the set-up of a new device to operate within a current system configuration, in which some embodiments of the present invention may operate. The specific components shown in FIG. 1 represent one example of a configuration that may be suitable for the invention and is not meant to limit the invention. Referring to FIG. 1, the environment may include, but is not necessarily limited to, a digital camera 102, a new device 104 with an associated device identifier 106, a media center 108, one or more devices 110 (shown as device 110-1 through 110-n), a display 112, an input device 114, storage 116, the Internet 118 and a Universal Product Code (UPC) database 120. Each of the components illustrated in FIG. 1 are described next in more detail.

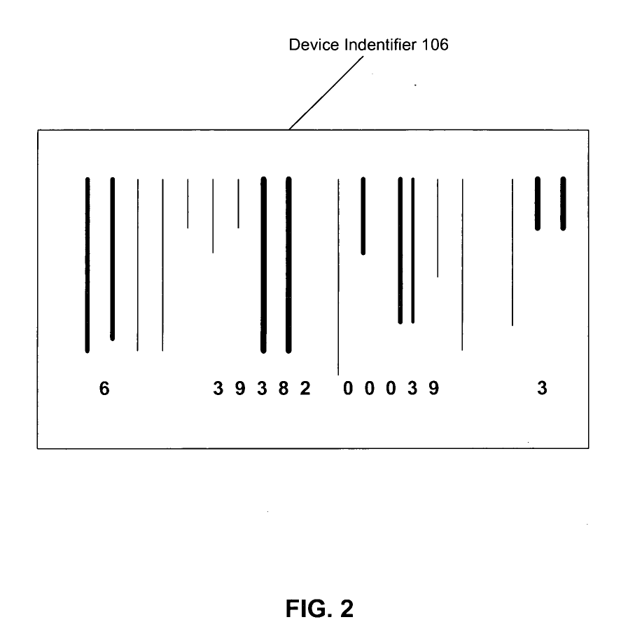

In an embodiment not meant to limit the invention, digital camera 102 is used to take a picture of device identifier 106 associated with new device 104. Device identifier 106 may be a UPC label, although this embodiment is not meant to limit the invention. A UPC label embodiment of the invention is described below with reference to FIG. 2. The picture of identifier 106 is then imported into media center 108 and used to identify new device 104. Based on the current system configuration, the user is provided with customized instructions on how to set-up new device 104 to operate within the current system configuration.

Media center 108 may be networked together with one or more of the components shown in FIG. 1. Therefore, media center 108 is able to perform status checks on the networked components and determine a current configuration of the system. Media center 108 is used for illustrations purposes only and may be any device that is capable of performing the functionalities described herein. For example, media center 108 could be replaced by a digital television (DTV), a personal computer, and so forth, that is adapted to perform the functionalities described herein. In an embodiment, the network may be an 802.11 wireless network. The network may also be a wired network that uses IEEE 1394 or firewire to connect the various components. The network may also be a combination of a wired and wireless network. Other networks may be added or substituted according to the particular application for the environment in FIG. 1 and/or as new types of networks are developed. These example types of networks are not meant to limit the invention.

Devices 110 may be any electronic device. Examples of devices 110 may include, but are not limited to, a television, a DVD player, a VCR player, a CD player, a set-top box, a stereo receiver, a media center, a PVR, a speaker system, and so forth. The present invention is not necessarily limited to typical devices found in a home or office. Although there are n devices shown in FIG. 1, the present invention may include one or more devices.

Display 112 may be any means of communicating the set-up instructions for new device 104 to the user. In an embodiment of the invention, display 112 is a screen that displays the set-up instructions. Input device 114 may be any means of providing information to media center 108.

Storage 116 may be any storage medium that is accessed by media center 108 to retrieve and store information. Storage 116 may store information related to the current system configuration, a device identification database, standard audio/video instructions showing how to configure devices, product information about the devices, and so forth. Media center 108 may have access to the Internet 118 in order to retrieve information from and/or download information to storage 116. In an embodiment of the invention, media center 108 may access UPC database 120 in order to identify a new device based on its UPC label.

As described above and in an embodiment of the invention, device identifier 106 may be a UPC label. UPCs originate with a company called the Uniform Code Council (UCC). A manufacturer applies to the UCC for permission to enter the UPC system. The manufacturer pays an annual fee for the privilege. In return, the UCC issues the manufacturer a six-digit manufacturer identification number and provides guidelines on how to use it. Referring to FIG. 2, an example standard UPC label is shown. The standard UPC number has two parts, the machine-readable bar code and the human-readable 12-digit UPC number. The first six digits of the UPC number shown in FIG. 2 (639382) is the manufacturer identification. The next five digits (00039) of the UPC number is the item number. Item numbers are assigned to products, making sure the same item number is not used on more than one product and retiring item numbers as products are removed from the product line, etc. The last digit (3) of the UPC number is called a check digit and is used by the scanner to determine whether the number was correctly scanned. In an embodiment of the invention, UPC database 120 may contain a listing of all device UPC label numbers and their corresponding device identity. The example UPC label shown in FIG. 2 is provided for illustration purposes only and is not meant to limit the invention.

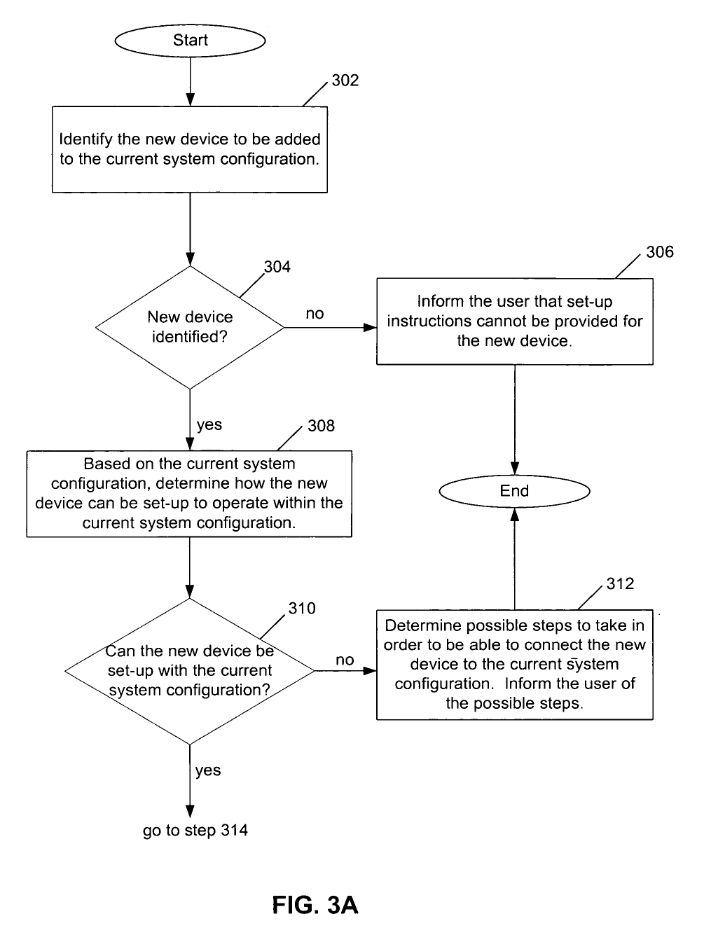

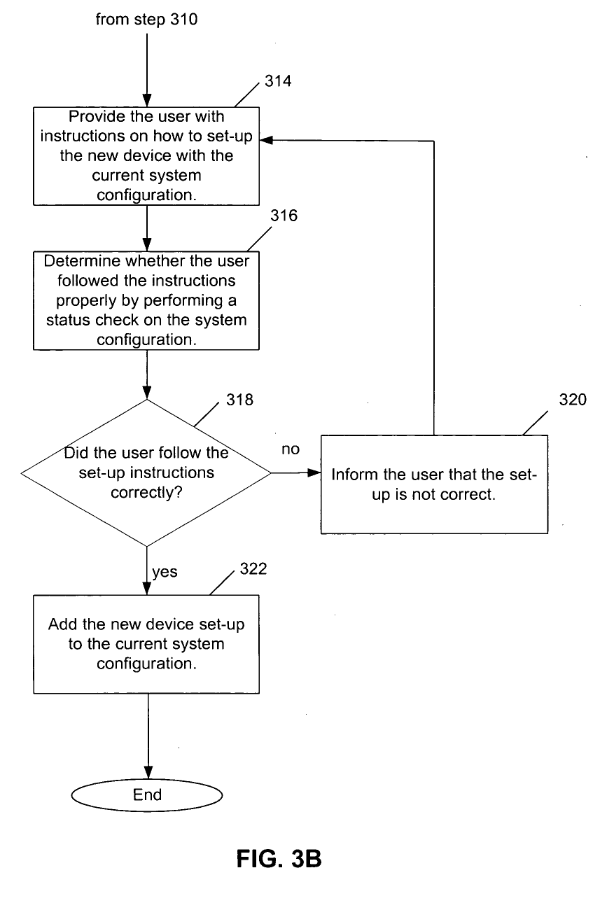

Embodiments of the operation of the present invention are described next with reference to FIGS. 3A, 3B and 4-6. The flow diagrams and other descriptions of processes herein are not intended to imply a fixed order of performing the process stages. Rather, the process stages may be performed in any order that is practicable.

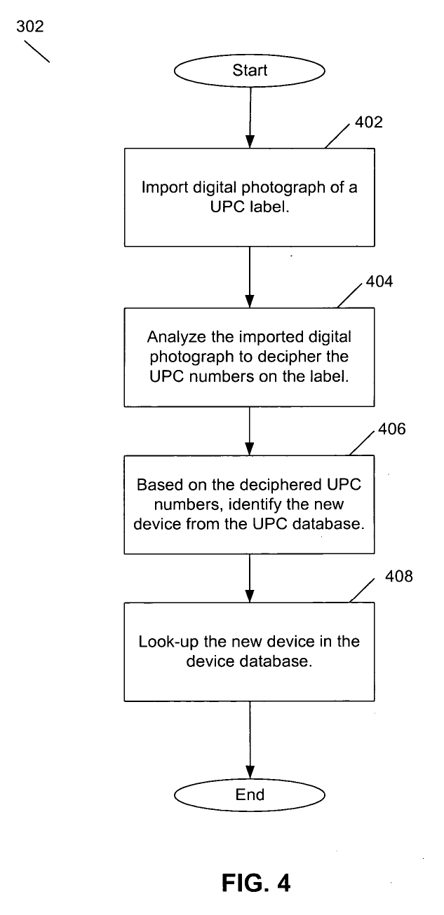

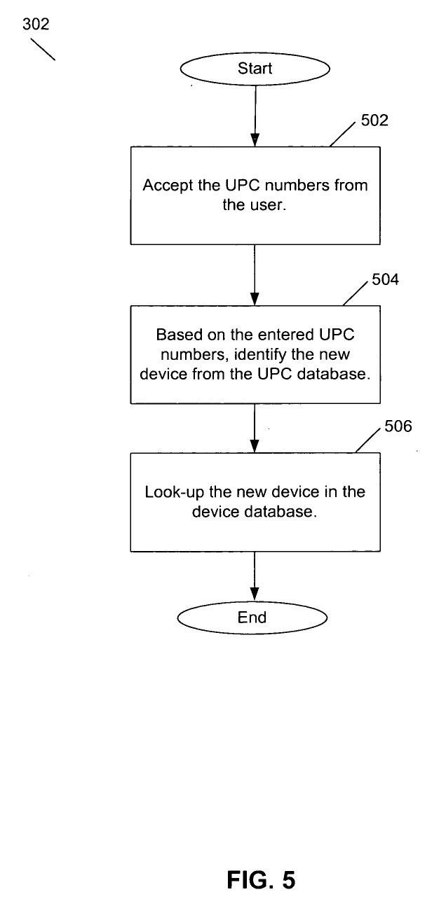

FIGS. 3A and 3B is a flow diagram of one embodiment of a process for the operation of assisting a user in the set-up of a new device to operate within a current system configuration. Referring to FIG. 3A, the process begins at processing block 302 where the new device (such as new device 104 in FIG. 1) is identified by the media center (such as media center 108 in FIG. 1). Processing block 302 is described below in more detail with reference to FIGS. 4 and 5. FIG. 4 describes an embodiment where the user uses a digital camera (such as digital camera 102 of FIG. 1) to take a photograph of the UPC label of the new device. The digital photograph of the UPC label is then analyzed by the media center to identify the UPC numbers. FIG. 5 describes an embodiment where the user reads the UPC numbers from the UPC label of the new device and provides the numbers directly to the media center via an input device (such as input device 114 of FIG. 1). In both embodiments, the UPC numbers may be used by the media center to identify the new device via a UPC database (such as UPC database 120 of FIG. 1).

If the new device cannot be identified at decision block 304, then the user is informed that set-up instructions cannot be provided for the new device (processing block 306). In an embodiment of the invention, the media center displays a message to the user on a display (such as display 112 of FIG. 1). The flow diagram in FIGS. 3A and 3B ends at this point.

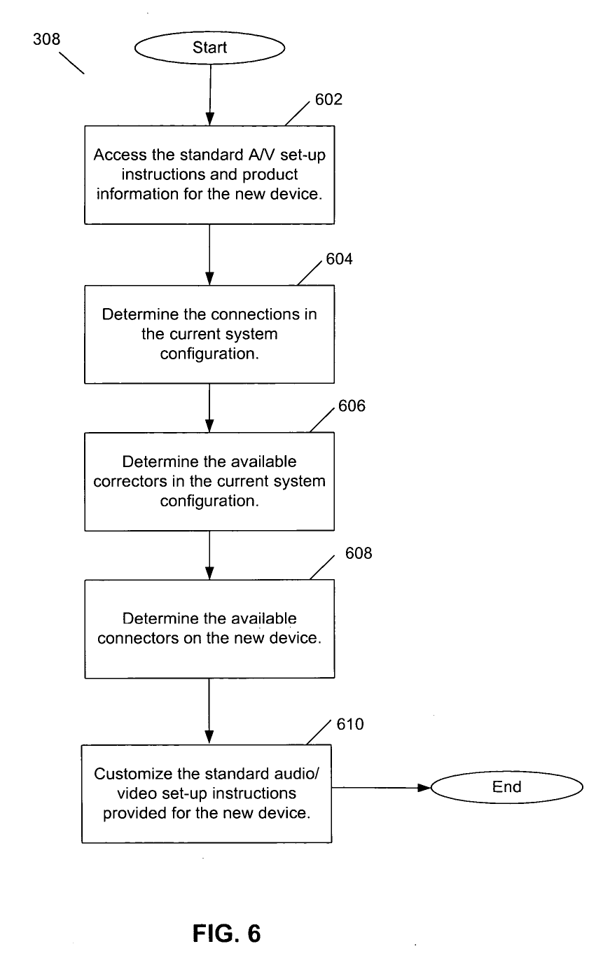

If the new device can be identified at decision block 304, then based on the current system configuration, it is determined how the new device can be set-up to operate within the system (processing block 308). In an embodiment of the invention, once the new device is identified, the media center has access to standard audio/video instructions showing how to configure the device and/or product information about the device. The media center may use this information, along with information on the current system configuration, to determine possible ways to set-up the new device. Processing block 308 is described below in more detail with reference to FIG. 6.

At decision block 310, if the new device cannot be set-up to operate within the current system configuration, then the media center determines possible steps to take in order to be able to connect the new device to the current system configuration (processing block 312). For example, all connectors on the media center may be already in use and thus the user may have to first purchase special equipment, etc., before the new device can be set-up to operate within the current system configuration. The media center may then inform the user of the necessary steps.

If at decision block 310 it is determined that the new device can be set-up to operate with the current system configuration, then at processing block 314 (FIG. 3B), the user is provided with instructions on how to set-up the new device to operate within the current system configuration. In an embodiment of the invention, the instructions are displayed to the user on a screen or display (such as display 112 in FIG. 1). The instructions may also be printed by the user in the event that one or more components in the system need to be powered off while the cables are being connected.

At processing block 316, the media center checks whether the user followed the instructions by performing a status check on the system configuration.

If at decision block 318 it is determined that the user did not follow the instructions properly, then the media center informs the user that the set-up is not correct (processing block 320). The user may then be provided the set-up instructions again (processing block 314).

If at decision block 318 it is determined that the user did follow the instructions properly, then the media center updates the current system configuration to include the addition of the new device (processing block 322). The flow diagram of FIGS. 3A and 3B ends at this point.

FIG. 4 is a flow diagram of one embodiment of a process for identifying the new device to be added to the current system configuration (step 302 of FIG. 3A). FIG. 4 describes an embodiment where the user uses a digital camera to take a photograph of the UPC label of the new device. Referring to FIG. 4, the process begins at processing block 402 where the digital photograph of the UPC label is imported into the media center. The digital photograph of the UPC label is then analyzed by the media center to decipher the UPC numbers (processing block 404). At processing block 406, the media center uses the deciphered UPC numbers to identify the new device via the UPC database. In an embodiment of the invention, the UPC database may contain a listing of all device UPC label numbers and their corresponding device identity. At processing block 408, the media center performs a look-up in a device database for the identified device. The flow diagram of FIG. 4 ends at this point.

FIG. 5 is a flow diagram of one embodiment of a process for identifying the new device to be added to the current system configuration (step 302 of FIG. 3A). FIG. 5 describes an embodiment where the user reads the UPC numbers from the UPC label of the new device and provides the numbers to the media center directly via an input device. Referring to FIG. 5, the process begins at processing block 502 where the media center accepts the UPC numbers from the user. At processing block 504, the media center then uses the entered UPC numbers to identify the new device via the UPC database. At processing block 506, the media center performs a look-up in a device database for the identified device. The flow diagram of FIG. 5 ends at this point.

FIG. 6 is a flow diagram of one embodiment of a process for determining how the new device can be set-up to operate within the system based on the current system configuration (step 308 of FIG. 3A). Referring to FIG. 6, the process begins at processing block 602 where the media center has access to standard audio/video set-up instructions showing how to configure the device and product information about the device. At processing block 604, the media center determines the connections in the current system configuration. The media center also determines the available correctors in the current system configuration (processing block 606). At processing block 608, the media center determines the available connectors on the new device. Based on all of this information determined by the media center, the media center customizes the standard audio/video set-up instructions provided for the new device (processing block 610). In an embodiment of the invention, there may be a different set-up audio/video sequence for each possible set of connectors that the user could use. For example, if the new device is a DVD player, then there may be instructions showing the set-up for using the component video outputs, the composite video outputs, the digital audio outputs, the SVHS video outputs, and so forth. The same may be true for audio outputs, video outputs and audio inputs. This example is provided for illustration purposes only and is not meant to limit the invention. The flow diagram in FIG. 6 ends at this point.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
identifying a new device to be added to a current system configuration, wherein the new device is identified via a Universal Product Code (UPC) number; and
based on the current system configuration, determining set-up instructions to enable the new device to operate within the current system configuration.

2. The method of claim 1, wherein the UPC number is obtained from a digital photograph of a UPC label associated with the new device.

3. The method of claim 1, wherein the UPC number is provided by a user.

4. The method of claim 1, wherein determining set-up instructions comprises:
accessing standard set-up instructions for the new device;
determining one or more connections in the current system configuration;
determining one or more available correctors in the current system configuration; and
customizing the standard set-up instructions based on the determined one or more connections and the determined one or more available correctors in the current system configuration.

5. The method of claim 1, further comprising determining whether the set-up instructions were executed properly, and if so, then adding a new device set-up to the current system configuration.

6. The method of claim 1, wherein the UPC number is used to identify the new device via a UPC database.

7. A system comprising:
a host device; and
one or more existing devices, wherein the host device and the one or more existing devices are networked together via a current system configuration, wherein the host device identifies a new device to be added to the current system configuration via a Universal Product Code (UPC) number associated with the new device, and wherein the host device determines set-up instructions to enable the new device to operate within the current system configuration.

8. The system of claim 7, wherein the host device is a media center.

9. The system of claim 7, wherein the UPC number is obtained from a digital photograph of a UPC label associated with the new device.

10. The system of claim 7, wherein the UPC number is provided by a user.

11. The system of claim 7, wherein the host device determines the set-up instructions by accessing standard set-up instructions for the new device, determines one or more connections in the current system configuration, determines one or more available correctors in the current system configuration, and customizes the standard set-up instructions based on the determined one or more connections and the determined one or more available correctors in the current system configuration.

12. The system of claim 7, wherein the host device determines whether the set-up instructions were executed properly, and if so, then adds a new device set-up to the current system configuration.

13. The system of claim 7, wherein the UPC number is used to identify the new device via a UPC database.

14. A machine-readable medium containing instructions which, when executed by a processing system, cause the processing system to perform a method, the method comprising:
identifying a new device to be added to a current system configuration, wherein the new device is identified via a Universal Product Code (UPC) number; and
based on the current system configuration, determining set-up instructions to enable the new device to operate within the current system configuration.

15. The machine-readable medium of claim 14, wherein the UPC number is obtained from a digital photograph of a UPC label associated with the new device.

16. The machine-readable medium of claim 14, wherein the UPC number is provided by a user.

17. The machine-readable medium of claim 14, wherein determining set-up instructions comprises:
accessing standard set-up instructions for the new device;
determining one or more connections in the current system configuration;
determining one or more available correctors in the current system configuration; and
customizing the standard set-up instructions based on the determined one or more connections and the determined one or more available correctors in the current system configuration.

18. The machine-readable medium of claim 14, further comprising determining whether the set-up instructions were executed properly, and if so, then adding a new device set-up to the current system configuration.

19. The machine-readable medium of claim 14, wherein the UPC number is used 41 identify the new device via a UPC database.
